(19) United States
(12) Patent Application Publication
(10) Pub. No.: US 2010/0039829 A1
(43) Pub. Date: Feb. 18, 2010

(54) LIGHT-EMITTING DIODE LAMP

(75) Inventor: Wen-Kuei Tsai, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: GE Investment Co., Ltd., Taipei City (TW)

(21) Appl. No.: 12/539,622

(22) Filed: Aug. 12, 2009

Related U.S. Application Data
(60) Provisional application No. 61/088,016, filed on Aug. 12, 2008.

(30) Foreign Application Priority Data
Aug. 6, 2009 (TW) 98214554

(51) Int. Cl. F21V 29/00

(52) U.S. Cl. 362/373

(57) ABSTRACT

A light-emitting diode (LED) lamp suitable for being electrically connected with a power supply includes a frame, a body connected to the frame, and an LED array module and a fan disposed on the body. The frame includes a bottom plate having an opening and a plurality of posts each having a first locking portion. The body has a base and a plurality of heat dissipation fins. The base has an accommodating space corresponding to the opening and a plurality of second locking portions. The second locking portions are respectively locked with the first locking portions. An air channel is between any two adjacent heat dissipation fins. The LED array module located in the accommodating space and the fan are electrically connected with the power supply. The fan is for generating an airflow blowing the air channels and the base for dissipating heat from the LED array module.

### CROSS-REFERENCE TO RELATED APPLICATION

This application claims the priority benefits of U.S. provisional application Ser. No. 61/088,016, filed on Aug. 12, 2008 and Taiwan patent application serial no. 98214554, filed on Aug. 6, 2009. The entirety of each of the above-mentioned patent applications is hereby incorporated by reference herein and made a part of specification.

### BACKGROUND OF THE INVENTION

1. Field of Invention

The invention relates to a light-emitting diode (LED) lamp and particularly to an LED lamp having favorable efficiency in heat dissipation.

2. Description of Related Art

A light-emitting diode (LED) is a semiconductor device that is fabricated basically by using a compound of chemical elements selected from groups III-V, such as GaP, GaAs, and so forth. This kind of semiconductor material has properties of converting electrical energy into light. More specifically, electrons and holes in the semiconductor material will be combined to release excessive energy in the form of light when a current is applied to the semiconductor material. Hence, LED can emit light.

As the light generated by LED is a form of cold luminescence instead of thermal luminescence or electric discharge luminescence, the lifespan of LED devices is up to one hundred thousand hours. And, LED devices do not require idling time. Moreover, LED devices have the advantages of fast response speed (about 10⁻⁹ seconds), compact size, low power consumption, low pollution (mercury-free), high reliability, capability for mass production, etc. Hence, the application of LED is fairly extensive. For example, LED can be used in large-sized display boards, traffic lights, cell phones, scanners, light sources for fax machines, and so forth.

In recent years, as the brightness and light-emitting efficiency of LED are being improved and the mass production of white light LEDs is carried out successfully, white light LEDs are used in illumination devices increasingly, such as indoor illuminators, outdoor illuminators, and so forth. Generally speaking, high-power LEDs all encounter heat dissipation problem. When an LED is operated in an overly high temperature, the brightness of the LED lamp may be reduced and the lifespan of the LED may be shortened. For these reasons, how to design a proper heat dissipation system for LED lamps has become a focus to researchers and designers in this field.

### SUMMARY OF THE INVENTION

The invention provides a light-emitting diode (LED) lamp having favorable efficiency in heat dissipation.

The invention provides an LED lamp suitable for being electrically connected with a power supply. The LED lamp includes a frame, a body, an LED array module, and a fan. The frame has a bottom plate and a plurality of posts connected with the bottom plate, wherein the bottom plate has an opening and each of the posts has a first locking portion. The body is connected to the frame. Furthermore, the body includes a base and a plurality of heat dissipation fins connected with the base. The base has an accommodating space and a plurality of second locking portions. An air channel is located between any two adjacent heat dissipation fins. The accommodating space is exposed corresponding to the opening, and the second locking portions are respectively locked with the first locking portions. The LED array module is disposed on the body and located in the accommodating space, wherein the LED array module is electrically connected with the power supply. The fan is disposed on the body and electrically connected with the power supply, wherein the fan covers an end of each of the heat dissipation fins and is suitable for generating an airflow blowing the air channels and the base for dissipating heat from the LED array module.

In one embodiment of the invention, the bottom plate has a top surface and a bottom surface opposite to the top surface, and each of the posts has a base portion and a rod portion. The base portion is fixed on the top surface and located between an edge of the opening and an outer periphery of the bottom plate. An extended direction of the rod portion is substantially perpendicular to an extended direction of the bottom plate.

In one embodiment of the invention, the LED lamp further includes a plurality of clamping elements. When the LED lamp is inserted into a board having a hole, the clamping elements and the bottom plate are suitable for clamping the board.

In one embodiment of the invention, each of the clamping elements has an elastic deformable end and a free end. The elastic deformable end is disposed on the posts, and the free end is adapted to moving toward the fan after being pressed. Moreover, the elastic deformable end provides a recovering force that enables the free end and the bottom plate to clamp the board.

In one embodiment of the invention, each of clamping elements includes a wire spring and a clamping portion. The wire spring is disposed on the posts. The clamping portion is connected with the wire spring, wherein the wire spring is adapted for providing recovering force that enables the clamping portion and the bottom plate to clamp the board.

In one embodiment of the invention, each of the first locking portions is a locking hole, and each of the second locking portions is a locking block.

In one embodiment of the invention, each of the first locking portions is a locking block, and each of the second locking portions is a locking hole.

In one embodiment of the invention, the body has an outer surface and a bottom surface corresponding to the opening. The accommodating space is positioned on the bottom surface. The heat dissipation fins surround the outer surface, and an extended direction of the heat dissipation fins is substantially the same as an extended direction of the posts. An end of each of the heat dissipation fins together form a platform, and the fan is located on the platform.

In one embodiment of the invention, the LED lamp further includes at least one tertiary optical device. The tertiary optical device is disposed on the body and located in the accommodating space, and a light-emitting surface of the tertiary optical device is exposed corresponding to the opening.

In one embodiment of the invention, the LED lamp further includes a secondary optical device. The secondary optical device is disposed on the body and located between the LED array module and the tertiary optical device. The secondary optical device is exposed corresponding to the opening.

In one embodiment of the invention, the LED lamp further includes a plurality of first fixing members, and the LED array module has a plurality of fixing holes. The first fixing members respectively pass through the fixing holes to fix the LED array module in the accommodating space of the body.

In one embodiment of the invention, the first fixing members include screws or screw bolts.

In one embodiment of the invention, the LED lamp further includes a plurality of second fixing member. The body has a plurality of first positioning holes and the fan has a plurality of second positioning holes. The second fixing members respectively pass through the second positioning holes and the first positioning holes to fix the fan on the body.

In one embodiment of the invention, the second fixing members include screws or screw bolts.

In one embodiment of the invention, the body is pivotally connected with the posts of the frame by the second locking portions and the first locking portions.

To conclude, the LED lamp of the invention has the fan and the heat dissipation fins disposed therein. Consequently, the heat generated by the LED array module can be actively dissipated by the fan and passively dissipated by the heat dissipation fins. As a result, the heat dissipation efficiency of the LED lamp is improved. In other words, the LED lamp of the invention would not be easily damaged due to overheating.

In order to make the aforementioned and other objects, features, and advantages of the invention more comprehensible, exemplary embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view of an LED lamp according to one embodiment of the invention.

FIG. 2 is a schematic exploded view of the LED lamp in FIG. 1.

FIG. 3 is a schematic perspective view depicting the LED lamp in FIG. 1 from another aspect.

FIG. 4A˜FIG. 4B illustrate a process of inserting the LED lamp in FIG. 1 into a hole of a board.

### DESCRIPTION OF EMBODIMENTS

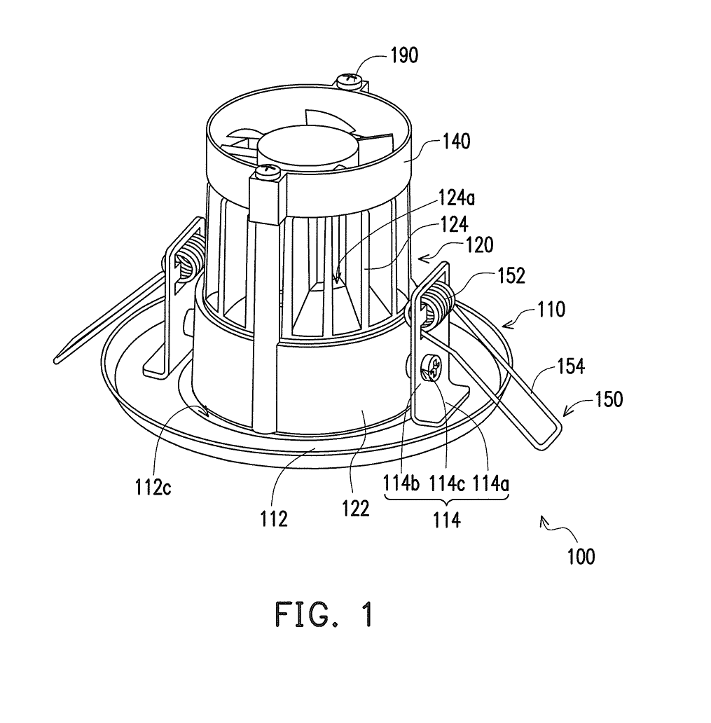

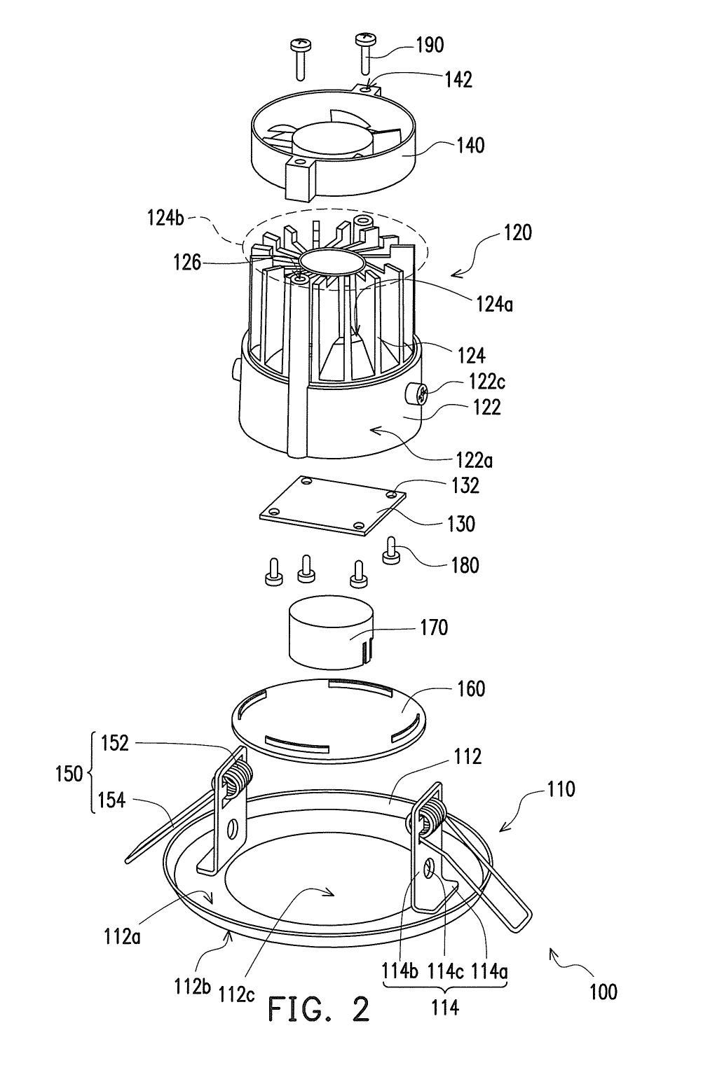

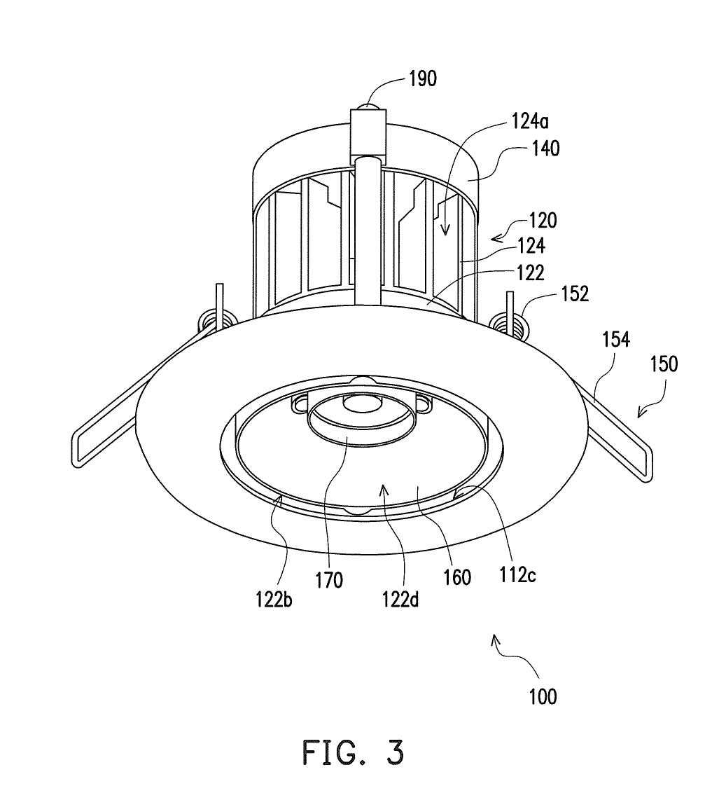

FIG. 1 is a schematic perspective view of an LED lamp according to one embodiment of the invention; FIG. 2 is a schematic exploded view of the LED lamp in FIG. 1; and FIG. 3 is a schematic perspective view depicting the LED lamp in FIG. 1 from another aspect. Referring to FIG. 1 and FIG. 2, in this embodiment, an LED lamp 100 is suitable for being electrically connected to a power supply (not shown). The LED lamp 100 includes a frame 110, a body 120, an LED array module 130, and a fan 140.

To be more specific, the frame 110 has a bottom plate 112 and a plurality of posts 114 connected with the bottom plate 112 (FIG. 1 and FIG. 2 illustrate two posts as an example). The bottom plate 112 has a top surface 112a, a bottom surface 112b opposite to the top surface 112a, and an opening 112c. Each of the posts 114 includes a base portion 114a, a rod portion 114b, and a first locking portion 114c. The base portions 114a are respectively fixed on the top surface 112a and located between an edge of the opening 112c and an outer periphery of the bottom plate 112. An extended direction of the rod portions 114b is substantially perpendicular to an extended direction of the bottom plate 112. Moreover, the first locking portions 114c are positioned on the rod portions 114b respectively. According to this embodiment, the bottom plate 112 and the posts 114 of the frame 110 can be formed in one piece, and a material of the frame 110 is SPCC, for example.

With reference to FIG. 2 and FIG. 3, the body 120 is connected to the frame 110. In addition, the body 120 has an outer surface 122a and a bottom surface 122b corresponding to the opening 112c. The body 120 includes a base 122 and a plurality of heat dissipation fins 124 connected with the base 122, wherein the base 122 has an accommodating space 122d and a plurality of second locking portions 122c. The accommodating space 122d is positioned on the bottom surface 122b and is exposed corresponding to the opening 112c of the bottom plate 112. The second locking portions 122c are respectively locked with the first locking portions 114c. The heat dissipation fins 124 surround the outer surface 122a of the body 120. Moreover, an air channel 124a is located between any two adjacent heat dissipation fins 124. An extended direction of the heat dissipation fins 124 is substantially the same as an extended direction of the rod portions 114b of the posts 114. An end of each of the heat dissipation fins 124 together forms a platform 124b. In this embodiment, the base 122 and the heat dissipation fins 124 of the body 120 can be formed in one piece, and a material of the body 120 is aluminum, for instance.

The LED array module 130 is disposed on the body 120 and located in the accommodating space 122d. Moreover, the LED array module 130 is electrically connected with the power supply. To be more detailed, in this embodiment, the LED array module 130 has a plurality of fixing holes 132 (FIG. 2 illustrates four holes as an example), and the LED lamp 100 includes a plurality of first fixing members 180 (FIG. 2 illustrates four fixing members as an example). The first fixing members 180 respectively pass through the fixing holes 132 to fix the LED array module 130 in the accommodating space 122d of the body 120. According to this embodiment, the first fixing members 180 are, for example, screws or screw bolts. The LED array module 130 is, for instance, formed by arranging a plurality of LEDs (not shown) on a circuit board (not shown), and the LEDs are electrically connected with the circuit board.

The fan 140 is disposed on the body 120 and located on the platform 124b that is formed by the ends of the heat dissipation fins 124. Furthermore, according to this embodiment, the body 120 has a plurality of first positioning holes 126 (FIG. 2 depicts two of the first positioning holes as an example), the fan has a plurality of second positioning holes 142 (FIG. 2 depicts two of the second positioning holes as an example), and the LED lamp 100 includes a plurality of second fixing members 190 (two of the second fixing members are depicted in FIG. 2 as an example). The second fixing members 190 respectively pass through the second positioning holes 142 and the first positioning holes 126 to fix the fan 140 on the body 120. According to this embodiment, the second fixing members 190 are, for example, screws or screw bolts.

In this embodiment, the fan 140 is electrically connected with the power supply to generate an airflow blowing the air channels 124a and the base 122 for dissipating heat from the LED array module 130. Since the fan 140 is fixed on the platform 124b by the second fixing members 190, when the LED array module 130 is powered to emit light, the fan 140 is powered to generate airflow which blows the air channels 124a and the base 122 for actively dissipating heat. At the same time, the heat dissipation fins 124 passively dissipate heat, so as to release heat from the LED array module 130. Therefore, the LED lamp 100 of this embodiment would not be easily damaged due to overheating. It is noted that, in other embodiments, the LED lamp 100 is supplied with a power of lower watt, for example, so that the fan 140 can be omitted. In other words, a designer can decide whether to add the fan 140 according to his requirements.

In this embodiment, the LED lamp 100 further includes a plurality of clamping elements 150, and each of the clamping elements 150 has an elastic deformable end 152 and a free end 154. The elastic deformable ends 152 are respectively disposed on the rod portions 114b of the posts 114. The free ends 154 are adapted to leaning against the outer periphery of the bottom plate 112 when not pressed by a force. Moreover, the LED lamp 100 further includes at least one tertiary optical device 160 (one is shown in FIG. 2 as an example) and a secondary optical device 170. The tertiary optical device 160 is disposed on the body 120 and located in the accommodating space 122d. A light-emitting surface of the tertiary optical device 160 is exposed corresponding to the opening 112c. The secondary optical device 170 is disposed on the body 120 and located between the LED array module 130 and the tertiary optical device 160. The secondary optical device 170 is exposed corresponding to the opening 112c. The tertiary optical device 160 can be a transparent plate, a mat mirror, or a lens. The tertiary optical device 160 as shown in FIG. 2 is, for example, a planar lens or a mat mirror, but the invention is not limited thereto. The secondary optical device 170 can be a reflector, a lamp cup, or a condenser. The secondary optical device 170 as shown in FIG. 2 is, for example, a reflector, but the invention is not limited thereto.

It is noted that, in this embodiment, the body 120 is pivotally connected with the posts 114 of the frame 110 by the second locking portions 122c and the first locking portions 114c. Accordingly, an angle of the body 120 is adjustable to change a direction of the light emitted from the LED array module 130. In addition, the first locking portions 114c are locking holes and the second locking portions 122c are locking blocks, for example. Of course, in other embodiments, the first locking portions 114c can be locking blocks and the second locking portions 122c can be locking holes adapted to the locking blocks. The first locking portions 114c and the second locking portions 122c as shown in FIG. 2 of this embodiment is merely one of the examples, and the invention is not limited thereto.

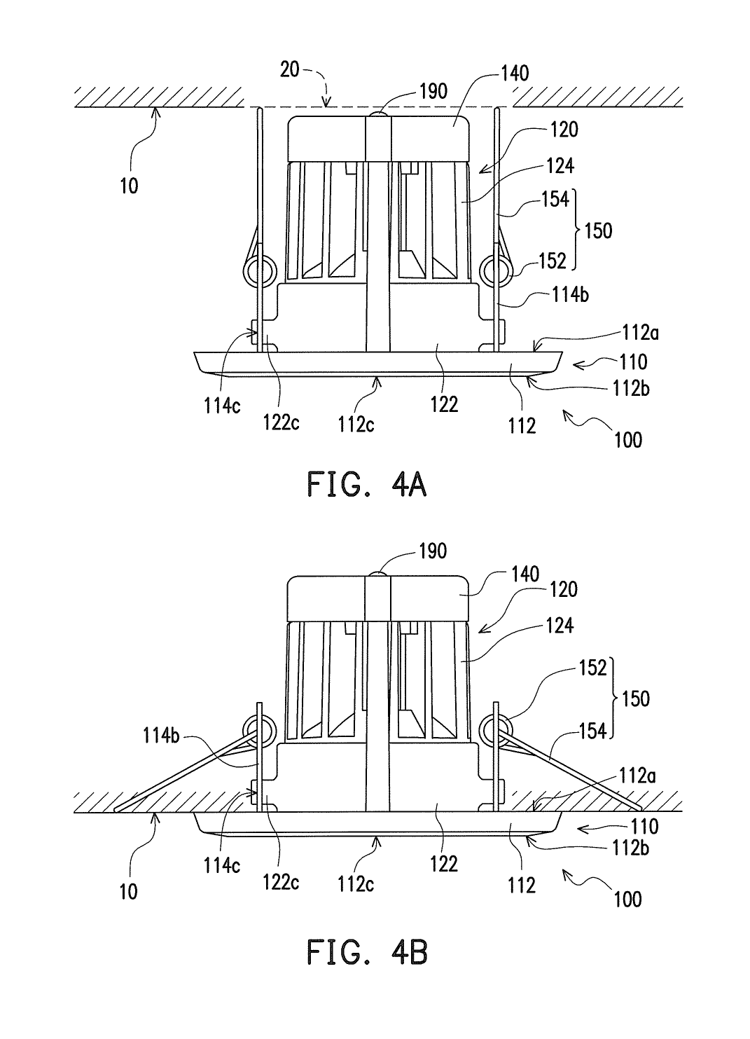

FIG. 4A˜FIG. 4B illustrate a process of inserting the LED lamp in FIG. 1 into a hole of a board. Referring to FIG. 4A and FIG. 4B, the LED lamp 100 of this embodiment is suitable for being inserted into a board 10 which has a hole 20. One type of the LED lamp 100 is, for example, an inserted lamp on ceiling. It is noted that, in this embodiment, a diameter of the hole 20 is smaller than an outer diameter of the bottom plate 112 and larger than a distance between the posts 114.

More specifically, when the LED lamp 100 is inserted into the hole 20 of the board 10, the free ends 154 of the clamping elements 150 are forced to move toward the fan 140. That is, an extended direction of the free ends 154 is nearly parallel to the extended direction of the rod portions 114b, such that the LED lamp 100 can be inserted into the hole 20. After the LED lamp 100 is inserted, the elastic deformable ends 152 respectively provide a recovering force which enables the free ends 154 and the bottom plate 112 to clamp the board 10.

The free ends 154 are maintained at an angle relative to the board 10 and are forced against a surface of the board 10. Because the outer diameter of the bottom plate 112 is larger than the diameter of the hole 20, the top surface 112a of the bottom plate 112 covers the other surface of the hole 20 while the bottom surface 112b of the bottom plate 112 is exposed outside the board 10. As a result, the clamping elements 150 and the bottom plate 112 clamp and hold the board 10. In other words, the board 10 is positioned between the clamping elements 150 and the bottom plate 112 after the LED lamp 100 is inserted into the hole 20. In this embodiment, the elastic deformable ends 152 of the clamping elements 150 are wire springs 152a and the free ends 154 of the clamping elements 150 are clamping portions, for example, but the invention is not limited thereto.

Based on the above, the LED lamp of the invention has the fan and the heat dissipation fins disposed therein. Consequently, the heat generated by the LED array module can be actively dissipated by the fan and passively dissipated by the heat dissipation fins. As a result, the heat dissipation efficiency of the LED lamp is enhanced. In other words, the LED lamp of the invention would not be easily damaged due to overheating.

Although the invention has been described with reference to the foregoing embodiments, it will be apparent to one of the ordinary skill in the art that modifications to the described embodiments may be made without departing from the spirit of the invention. Accordingly, the scope of the invention is defined by the attached claims not by the above detailed description.

What is claimed is:

1. A light-emitting diode (LED) lamp suitable for being electrically connected with a power supply, the LED lamp comprising:
a frame having a bottom plate and a plurality of posts connected with the bottom plate, wherein the bottom plate has an opening and each of the posts has a first locking portion;
a body connected to the frame, the body comprising a base and a plurality of heat dissipation fins connected with the base, wherein the base comprises an accommodating space and a plurality of second locking portions, an air channel is located between any two adjacent heat dissipation fins, the accommodating space is exposed corresponding to the opening, and the second locking portions are respectively locked with the first locking portions;
an LED array module disposed on the body and located in the accommodating space, wherein the LED array module is electrically connected with the power supply; and
a fan disposed on the body and electrically connected with the power supply, wherein the fan covers an end of each of the heat dissipation fins and is suitable for generating an airflow blowing the air channels and the base for dissipating heat from the LED array module.

2. The LED lamp as claimed in claim 1, wherein the bottom plate has a top surface and a bottom surface opposite to the top surface, each of the posts has a base portion and a rod portion, the base portion is fixed on the top surface and located between an edge of the opening and an outer periphery of the bottom plate, and an extended direction of the rod portion is substantially perpendicular to an extended direction of the bottom plate.

3. The LED lamp as claimed in claim 2, further comprising a plurality of clamping elements, wherein the clamping elements and the bottom plate are adapted for clamping a board when the LED lamp is inserted into a hole of the board.

4. The LED lamp as claimed in claim 3, wherein each of the clamping elements comprises an elastic deformable end and a free end, the elastic deformable end is disposed on the post, the free end is adapted to moving toward the fan when being pressed by a force, and the elastic deformable end provides a recovering force enabling the free end and the bottom plate to clamp the board.

5. The LED lamp as claimed in claim 3, wherein each of the clamping elements comprising:
a wire spring disposed on the post; and
a clamping portion connected with the wire spring, wherein the wire spring is suitable for providing a recovering force enabling the clamping portion and the bottom plate to clamp the board.

6. The LED lamp as claimed in claim 1, wherein each of the first locking portions is a locking hole and each of the second locking portions is a locking block.

7. The LED lamp as claimed in claim 1, wherein each of the first locking portions is a locking block and each of the second locking portions is a locking hole.

8. The LED lamp as claimed in claim 1, wherein the body comprises an outer surface and a bottom surface corresponding to the opening, the accommodating space is positioned on the bottom surface and the heat dissipation fins surround the outer surface, an extended direction of the heat dissipation fins is substantially the same as an extended direction of the posts, and an end of each of the heat dissipation fins together form a platform on which the fan is disposed.

9. The LED lamp as claimed in claim 1, further comprising at least one tertiary optical device disposed on the body and located in the accommodating space, and a light-emitting surface of the tertiary optical device being exposed corresponding to the opening.

10. The LED lamp as claimed in claim 9, further comprising a secondary optical device disposed on the body and located between the LED array module and the tertiary optical device, and the secondary optical device being exposed corresponding to the opening.

11. The LED lamp as claimed in claim 1, further comprising a plurality of first fixing members, wherein the LED array module has a plurality of fixing holes and the first fixing members respectively pass through the fixing holes to fix the LED array module in the accommodating space of the body.

12. The LED lamp as claimed in claim 11, wherein the first fixing members comprise screws or screw bolts.

13. The LED lamp as claimed in claim 1, further comprising a plurality of second fixing members, wherein the body has a plurality of first positioning holes, the fan has a plurality of second positioning holes, and the second fixing members respectively pass through the second positioning holes and the first positioning holes to fix the fan on the body.

14. The LED lamp as claimed in claim 13, wherein the second fixing members comprise screws or screw bolts.

15. The LED lamp as claimed in claim 1, wherein the body is pivotally connected with the posts of the frame by the second locking portions and the first locking portions.
